(19) United States
(12) Patent Application Publication
(10) Pub. No.: US 2025/0156224 A1
(43) Pub. Date: May 15, 2025

(54) DETERMINING INCIDENT IMPACT TO AN APPLICATION USING COMPARABLE HISTORICAL DATA

(71) Applicant: MASTERCARD INTERNATIONAL INCORPORATED, Purchase, NY (US)

(72) Inventor: James David Lorenz, Ballwin, MO (US)

(21) Appl. No.: 18/946,438

(22) Filed: Nov. 13, 2024

Related U.S. Application Data
(60) Provisional application No. 63/598,538, filed on Nov. 13, 2023.

(51) Int. Cl. G06F 9/50; G06F 11/07

(52) U.S. Cl. CPC G06F 9/50; G06F 11/076

(57) ABSTRACT

A computerized method for determining impact of an incident, during the incident, using an AI engine is provided. A stream of transactions is received, and traffic patterns are generated over a predefined time period from the stream of transactions. The traffic patterns are compared with data stored in a historical data warehouse, the data being from a time period that is statistically similar to the current incident time period yet prior to the incident occurring. A running impact count of transactions is determined based on the comparison. The running impact count is dynamically updated as the incident is occurring and displayed in a dashboard. Thus, aspects of the disclosure provide a real-time assessment of the predicted impact of the incident.

### BACKGROUND

Incidents are events that occur in a computing infrastructure that negatively affect the operation of computing components (e.g., hardware, software, firmware, etc.) in the computing infrastructure. Examples of incidents include hardware failures, network outages, power outages, security breaches, data center failures, software bugs or crashes, operating system failures, storage device failures, database failures, network traffic surges, human errors, or the like. When an incident impacts an application or a computing device, it is difficult to accurately determine, during the incident, the impact to the application, computing device, or other computing components. While some existing systems can go back and attempt to analyze the impact of incident after the incident has been resolved, it is difficult during the incident to determine the expected length of the impact period, the transactions that are predicted to not be occurring because of the incident, and the quantity of the computing components that will ultimately be affected.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An example computerized method for determining impact of an incident while the incident is occurring is described. The start of an incident is detected, and a stream of impacted transactions is received during the incident. A transaction traffic pattern is identified over a defined impacted time period from the stream of impacted transaction. An artificial intelligence (AI) engine is used to compare the identified transaction traffic pattern with data stored in a historical data warehouse, wherein the data stored in the historical data warehouse comprises historical transaction traffic patterns prior to the incident. Based on the comparing, a running impact count of transactions is determined by the AI engine, wherein the running impact count indicates a quantity of transactions predicted to be missed. A dashboard user interface is used to display the running impact count, and the running impact count is dynamically updated as the incident is on-going.

### BRIEF DESCRIPTION OF THE DRAWINGS

The present description will be better understood from the following detailed description read considering the accompanying drawings, wherein:

FIG. 1 is a block diagram illustrating an example system configured for determining impact of an incident during incubation period using an artificial intelligence (AI) engine;

FIG. 2 is a flowchart illustrating an example method for determining impact of an incident during incubation period using the AI engine;

FIG. 3 is a flowchart illustrating an example method for displaying running impact count and final impact counts of an incident using the AI engine;

FIG. 4 is a block diagram illustrating an example system configured to analyze the impact of an incident on associated transactions;

FIG. 5 is a block diagram illustrating an example incident impact dashboard; and

FIG. 6 illustrates an example computing apparatus as a functional block diagram.

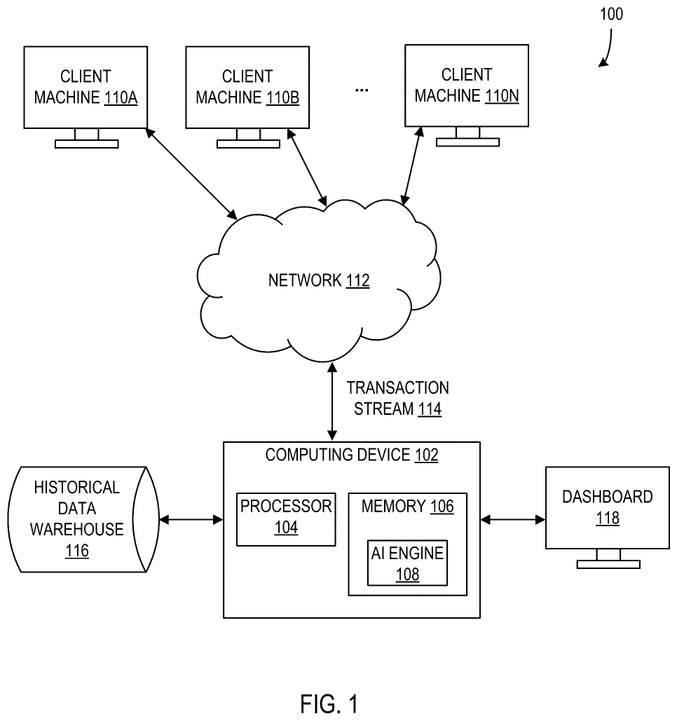

Corresponding reference characters indicate corresponding parts throughout the drawings. In FIGS. 1 to 6, the systems are illustrated as schematic drawings. The drawings may not be to scale. Any of the figures may be combined into a single example or embodiment.

### DETAILED DESCRIPTION

Incidents are events that occur in a computing infrastructure that negatively affect the operation of computing components (e.g., hardware, software, firmware, etc.) in the computing infrastructure. Examples of incidents include hardware failures, network outages, power outages, security breaches, data center failures, software bugs or crashes, operating system failures, storage device failures, database failures, network traffic surges, human errors (e.g., misconfiguration, accidental data deletion, etc.), natural disasters, software updates (e.g., which could introduce compatibility issues), dependency failures (e.g., if an application relies on external services or application programming interfaces (APIs) that become faulty), capacity issues (e.g., running out of storage, memory, and/or processing capacity), domain name system (DNS) failures, data corruption, virus attacks, and/or malware attacks.

When an incident impacts an application or a computing device, it is difficult to accurately determine, during the incident, the impact to the application, computing device, or other computing components. For example, while some existing systems can go back and attempt to analyze the impact of incident after the incident has been resolved, it is difficult during the incident to determine the expected length of the impact period, the transactions that are predicted to not be occurring because of the incident, and the quantity of the computing components that will ultimately be affected. In a particular example, if a malfunctioning firewall reduces the number of transactions being passed through to a server, existing systems fail to accurately predict, during the malfunctioning, the number of transactions that are being missed, and/or will be missed, due to the malfunctioning.

In some examples, aspects of the disclosure determine an impact of an incident during the incident (e.g., starting when the incident has started). As an example, an incident occurs, and a start time (e.g., date and time) of the incident is recorded. To determine the impact of the incident, during the incident, aspects of the disclosure identify a transaction traffic pattern (e.g., a set of transactions, or any other group of transactions) during a time period during the incident (e.g., during an incubation period). The incubation period may be any period up to a threshold time period (e.g., 10 minutes, 30 minutes, 60 minutes, etc.) after the incident occurrence, after the incident is detected, or during the incident. The transaction traffic pattern during the incubation period is compared with data stored in a historical data warehouse. The historical data warehouse stores historical traffic patterns of transactions prior to the incident. In some examples, the data stored in the historical data warehouse includes data associated with time periods corresponding to one or more earlier incidents and/or with time periods not corresponding to any earlier incident.

The AI engine uses the traffic pattern of transactions collected during the incubation period to identify a comparable, earlier time period. The comparable, earlier time period is a time period that is statistically similar to the incubation period. The AI engine performs the comparison and predicts the impact of the current incident based on the transactions that occurred during earlier, comparable time period(s). Based on the comparison, the AI engine predicts a running impact count of missing transactions, reflecting the transactions that are predicted to not be occurring (or completing) during the incident.

For example, from the data stored in the historical data warehouse, the historical transaction traffic patterns associated with the statistically similar time period are extracted. Deduplication is applied, using the AI engine, to the historical transaction traffic patterns associated with the statistically similar time period, to get an accurate, predicted view of the impact of the current incident. Deduplication eliminates the duplicate transactions. For example, if a customer gets an invalid or failure response, they may try to resubmit the transaction. This is not counted as a unique, new transaction. Rather, it is a retry of the original transaction. From an impact count perspective, it is only considered one “failed” transaction. In cases involving 1,000 s or 100,000 s of transactions, this can be a statistically significant number. The AI engine runs deduplication logic against the predicted impact counts which significantly reduces the processing and memory requirements.

In some examples, a comparable data set (or previous transactions during the comparable, earlier, incident time period) is created in real-time as the stream of transactions is received. The comparable data set represents the predicted transactions that would be received in the stream of transactions during the incubation time period, if the incident were not occurring). The comparable data set may also be referred to as a healthy baseline.

In some examples, the duration of the incubation period, used for identifying a comparable, earlier time period, is automatically configured based on the time periods corresponding to one or more earlier comparable traffic patterns. For example, the incubation period used may be longer when the incubation period of at least one comparable, earlier traffic pattern is longer, and shorter when the incubation period of at least one comparable, earlier traffic pattern is shorter.

The predicted, running, impact count may be displayed to a user on a dashboard in a user interface. The predicted running impact count may be dynamically updated based on output of the AI engine. For example, the running impact count displayed in the dashboard comprises one or more of: a number of transactions impacted, an expected volume of transactions, an actual volume of transactions detected, a percentage of volume impact, and/or a percentage of volume successful.

The number of transactions impacted may reflect a reduced number of transactions, or an additional number of transactions, processed due to the impact of the incident. The expected volume of transactions may represent the number of transactions that are expected due to the impact of the incident. For example, an expected volume of transactions equals the number of transactions received before the incident, plus or minus the number of transactions impacted. The actual volume of transactions may be the number of transactions actually being received during the incident. A percentage of volume impact, and a percentage of volume successful, are also calculated and/or estimated, and shown to the user. For example, a percentage of volume impact and a percentage of volume successful are calculated by:

$$Volume Impact \% = \frac{Total Volume - Impacted Volume}{Total Volume} * 100$$

$$Success \% = \frac{Total Volume - Successful Volume}{Total Volume} * 100$$

Upon detecting an end of the incident, a final impact count may be determined based on the data stored in the historical data warehouse. The final impact count is displayed in the dashboard by the AI engine. In some examples, displaying the final impact count is in addition to the earlier displayed running impact count in the dashboard. In some other examples, displaying the final impact count replaces the earlier displayed running impact count in the dashboard.

Some examples of the disclosure operate in an unconventional manner at least by comparing impacted traffic patterns to historical transaction traffic patterns (e.g., using an AI model/engine) and, by that comparison, determining the running impact of the incident. The determination and display of the running impact of the incident provides accurate information about the incident that can then be used to make decisions about the incident and/or otherwise address the incident. The use of the AI engine by the disclosure results in increased efficiency of use of the computing resources of the system and the real-time provision of impact information is a substantial performance improvement over other systems that do not use such an AI engine.

Further, by utilizing historical data and deduplication methods, the system accurately predicts the quantity of transactions missed during an incident, providing on-going insights into the scope of disruption. This predictive approach facilitates immediate decision-making and resource allocation adjustments during incidents, enhancing system resiliency and operational continuity. The incorporation of AI allows for efficient processing and analysis of large transaction volumes, thereby improving incident management by offering timely assessments and enabling proactive measures to mitigate potential impacts. The dynamic updating of the impact count and its display in a dashboard interface further supports real-time monitoring and management of incident effects, providing stakeholders with essential data-driven insights for effective incident response.

The described system and method for determining incident impact using comparable historical data constitutes a practical application of a technological process that provides a technological solution to a specific problem in computing infrastructures. The invention involves the use of an artificial intelligence (AI) engine and a computer-implemented method that processes transaction data in real-time to assess the impact of incidents affecting computing components such as hardware, software, or firmware.

This solution improves upon existing methodologies by leveraging AI techniques and historical transaction patterns to dynamically assess ongoing incidents. It involves concrete steps, such as detecting an incident start, receiving and analyzing transaction data, identifying traffic patterns, and using these patterns to perform AI-driven comparisons with historical data. Consequently, the system determines a running impact count, which is updated dynamically and displayed via a user interface, thereby enhancing decision-making and resource allocation during incidents.

As a system comprising tangible components, including processors and memory with specific programmed functionalities, the invention aligns with recognized categories of patent-eligible subject matter, namely, machines, processes, and computer-readable storage media. The implementation of AI to process and analyze large volumes of data in a novel real-time manner, providing actionable insights for stakeholders, signifies a marked improvement over traditional, non-computerized practices.

FIG. 1 is a block diagram illustrating an example system configured for determining impact of an incident during the incubation period using the AI engine. In some examples, the system 100 includes a computing device 102 that comprises a processor 104 and a memory 106. In some examples, the AI engine 108 may be stored in the memory 106 (as shown). In other examples, the AI engine 108 may be stored outside the memory 106 e.g., on the cloud (not shown). The system 100 includes client machines 110A-110N which perform the transactions over the network 112. The transactions may be performed to access the computing device 102 (as shown) or some other device (not shown). The transactions may be payment transactions performed by users of the client machines 110A-110N on the cloud over the network 112.

A start of the incident is detected. An exemplary incident may be a malfunction of an application on the computing device 102 or any other component of the system 100, e.g., a firewall (not shown) configured to filter network traffic to and from the computing device 102. A malfunctioning of the firewall may result in a result in a reduction in the number of transactions because the firewall may restrict all transactions. Alternatively, a malfunctioning of the firewall may result in a result in an increase in the number of transactions because even unauthorized transactions may bypass the firewall.

The transactions may be received by the computing device as transaction stream 114. The AI engine 108 identifies transaction traffic patterns over a predefined time period from the transaction stream 114, during the incident. The transaction traffic patterns are compared with data stored in a historical data warehouse 116, and a running impact count of transactions is determined.

The running impact count may be displayed in a dashboard 118 using the AI engine 108. For example, the running impact count, displayed in the dashboard 118, comprises one or more of a number of transactions impacted, an expected volume of transactions, an actual volume of transactions, a percentage of volume impact, and a percentage of volume successful. In some examples, the AI engine 108 may be used to infer on missing data due to the incident (e.g., missing transactions due to the incident) such that determining the running impact count comprises predicting the running impact count based on the inferring.

In some examples, The updated running impact count can be integrated with automated alerting systems that notify relevant stakeholders in real-time. This use case enables prompt awareness and response from IT teams, ensuring that timely interventions can be deployed to mitigate impacts. Alerts are configured to trigger when the running impact count surpasses predefined thresholds, thereby prioritizing severe incidents for immediate attention.

Alternatively, or additionally, the updated running impact count can be used to dynamically adjust resource allocation. By monitoring the impact in real-time, the system can reallocate processing power, memory, or storage capacities to areas most affected by an incident. This ensures optimal resource usage, helping to maintain system performance and minimize disruption.

Further, in some examples, the running impact count can be used as a key input into incident forecasting models. By analyzing real-time data, alongside historical patterns, organizations can simulate potential future incidents and their impacts, allowing for improved preparedness and strategic planning.

Additionally, or alternatively, customer support teams can utilize the running impact count to inform users about expected service disruptions and recovery timelines. This real-time data enables more accurate and timely communication, enhancing customer trust and reducing the potential for dissatisfaction.

In some such examples, for enterprise environments with interdependent systems, the running impact count can aid in coordinating recovery efforts across multiple systems. By providing a unified view of impacts, the count assists in aligning priorities and actions across different teams and platforms to ensure comprehensive incident resolution.

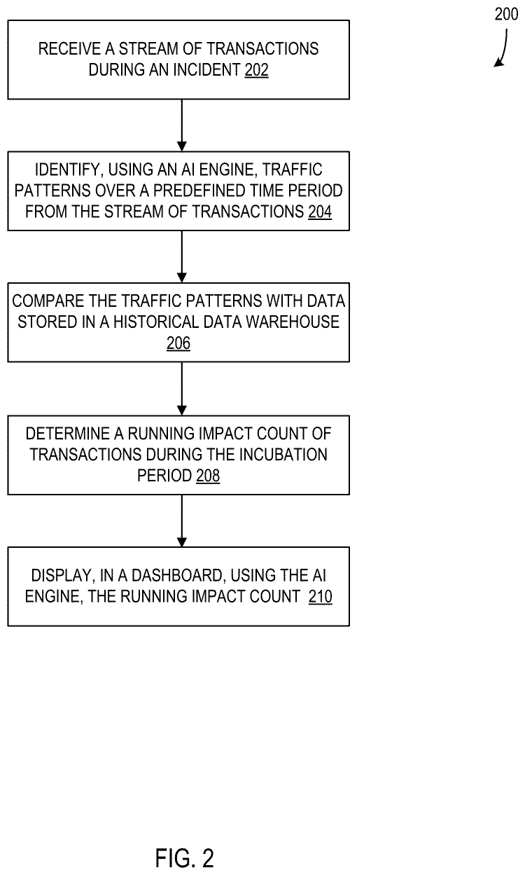

FIG. 2 is a flowchart illustrating an example method 200 for determining impact of an incident, during the incident, using the AI engine. At 202, a stream of transactions is received during an incident. At 204, transaction traffic patterns are identified using an AI engine over a predefined time period from the stream of transactions. At 206, the transaction traffic patterns are compared with data stored in a historical data warehouse.

At 208, a running impact count of transactions is determined, as the incident is occurring. At 210, the running impact count may be displayed in a dashboard using the AI engine. The running impact count is updated dynamically (e.g., as time goes on). For example, the running impact count may be updated as transactions are received (e.g., at a reduced rate or an increased rate) in the transaction stream due to the incident. In general, the running impact count represents the predicted quantity of transactions not being completed due to the ongoing incident. The changes in the running impact count due to the incident are dynamically updated in the dashboard. The running impact count displayed in the dashboard comprises one or more of a number of transactions impacted, an expected volume of transactions, an actual volume of transactions, a percentage of volume impact, and a percentage of volume successful.

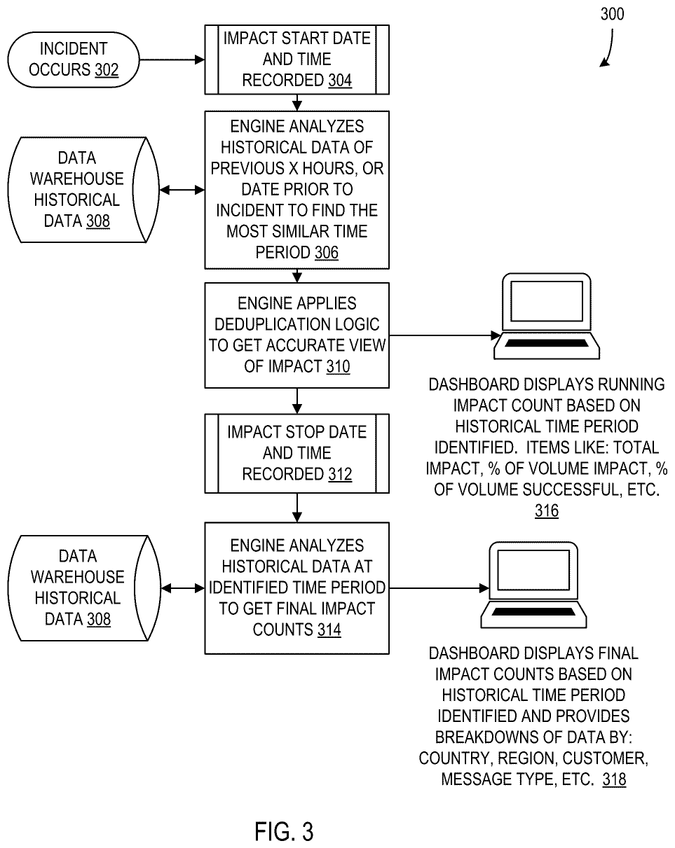

FIG. 3 is a flowchart illustrating an example method 300 for displaying running impact count and final impact counts of an incident using the AI engine. At 302, occurrence of an incident is detected. At 304, impact start date and time is recorded based on the detected occurrence of the incident. At 306, the AI engine analyzes historical data associated with a previous quantity of hours, or a date prior to the incident to find a similar time period (e.g., the most similar time period). The historical data is stored in a data warehouse 308. The AI engine uses the number of transactions that were completed during that similar time period for comparison with the current quantity of transactions being completed during the incident (e.g., during the incubation period). At 310, the AI engine applies deduplication logic to get an accurate view of impact of the incident. The result is that the AI engine predicts, calculates, or otherwise determines the running impact of the incident. At 316, a dashboard displays a running impact count based on the historical time period identified. Items like total impact, percentage of volume impact, percentage of volume successful, etc. are displayed in the dashboard at 316. The impact count includes a dynamic quantity of transactions that are predicted to not be completed during the on-going incident.

In some examples, while the dashboard is displayed and dynamically updated at 316 (after 310), the method 300 continues until the impact stop date and time is recorded at 312. At 314, the AI engine analyzes historical data at the identified prior time period to get final impact counts from the data warehouse storing historical data 308. At 318, the dashboard displays final impact counts and optionally provides a breakdown of the data by country, region, customer, message type, etc.

In this manner, the AI engine is able to provide practical information about the incident, such as the quantity of transactions that would have been seen, received, processed, performed, etc. if the incident had not occurred. Alternatively, the transactions may include the additional transactions that actually have been performed during the incident.

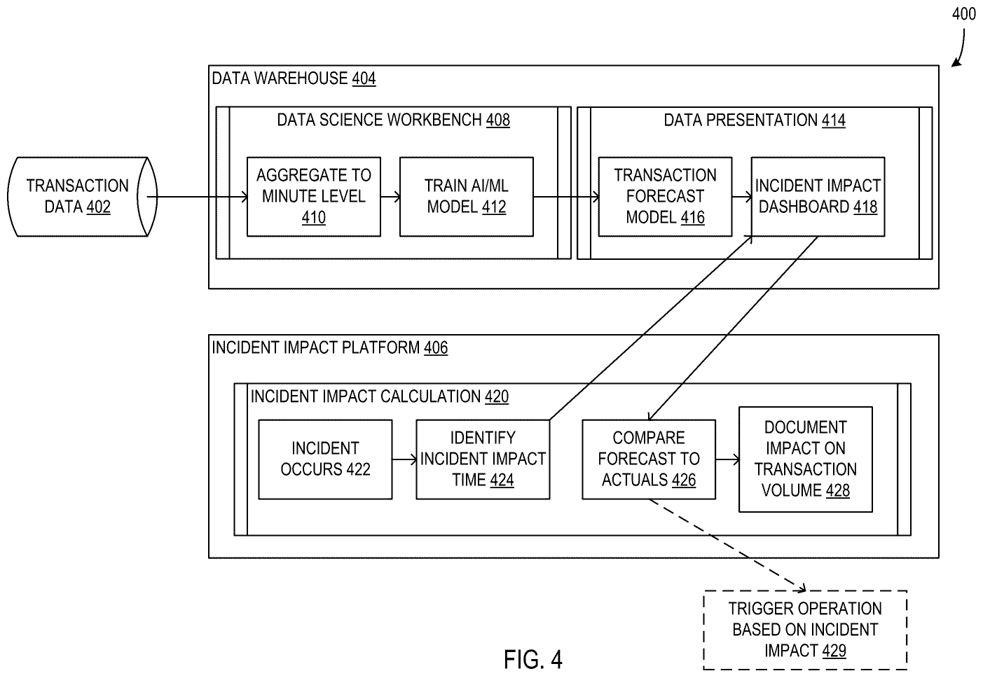

FIG. 4 is a block diagram illustrating an example system 400 configured to analyze the impact of an incident on associated transactions. In some examples, the system 400 is part of or otherwise associated with a system such as system 100 of FIG. 1.

In some examples, the system 400 includes transaction data 402 (e.g., transaction data from a historical data warehouse 116) that is analyzed using a data science workbench 408 associated with the data warehouse 404. The analysis includes aggregating the transaction data 402 to the minute level at 410 (e.g., organizing the transactions into groups based on the specific minute-long timeframes in which they occurred) and those aggregated transactions are used to train the artificial intelligence/machine learning (AI/ML) model (e.g., the AI engine 108) at 412.

In some such examples, the AI/ML model is trained to identify statistically similar time periods in the transaction data 402 when given data associated with a specific time period. For instance, in some examples, the AI/ML model is trained as a classification model that then “classifies” transaction data 402 time periods as being statistically similar to an input time period based on data and/or statistics associated with the two time periods (e.g., length of time period, time of day of the time period, similar data sources of the transaction data for the time period, or the like).

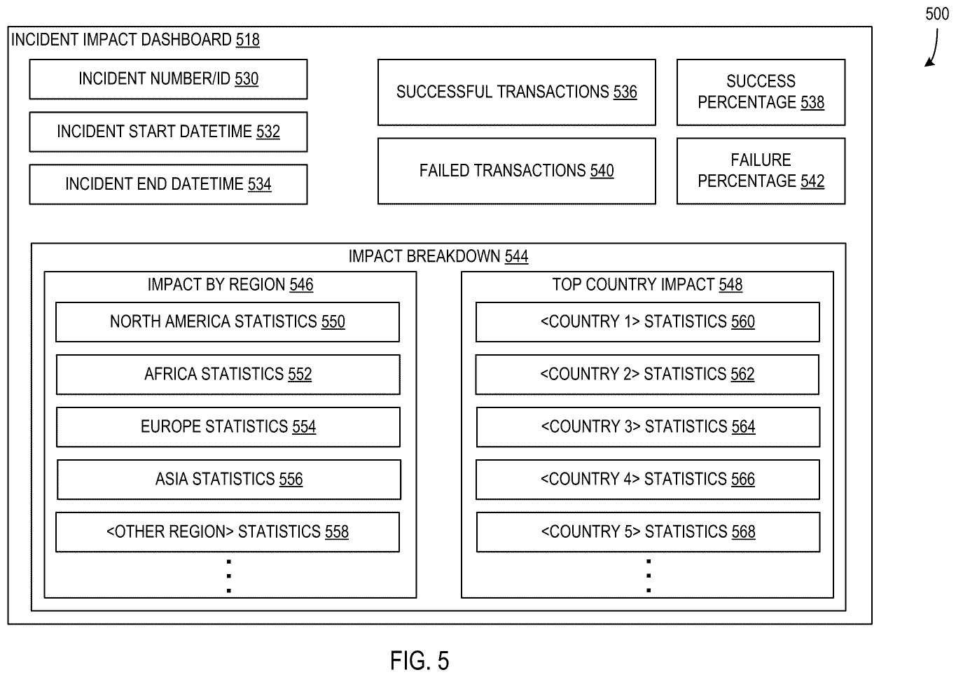

The trained model, or transaction forecast model 416, is provided for use in the data presentation 414 portion of the data warehouse 404. The transaction forecast model 416 is used during the calculation of the incident impact as described herein and the resulting incident impact is then displayed on the incident impact dashboard 418. An example of an incident impact dashboard 418 is provided in FIG. 5 and the associated description below.

In some examples, an incident impact platform 406 is configured to detect or otherwise obtain information about incidents and to calculate the impact of those incidents as described herein. The incident impact calculation 420 process includes the occurrence of the incident at 422, the identification of the incident impact time at 424, the comparison of a transaction forecast to the actual transaction data at 426, and the documentation of the calculated impact on transaction volume at 428. During the execution of the incident impact calculation 420, the process interacts with the incident impact dashboard 418 and the associated transaction forecasts from the transaction forecast model 416. Time data of the incident is provided to the incident impact dashboard 418 for display and the transaction forecast data is provided to the incident impact platform 406 for use in the incident impact calculation 420.

Further, in some examples, the system 400 includes the execution or performance of an operation in response to or based on the determined incident impact at 429. For instance, in an example, a notification is generated and/or presented to a user (e.g., via the incident impact dashboard 418) that indicates a degree to which the incident has impacted an aspect of the system 400 operation and a recommended action that the notified user can take to end or otherwise address the incident. Alternatively, or additionally, in an example, the operation performed at 429 includes analyzing the incident, determining a method of detecting similar future incidents, and/or generating a system rule associated with preventing or otherwise reducing the effect of similar future incidents.

In an embodiment, the disclosed system 400 and associated methods further incorporate a machine learning model that dynamically adjusts its predictive algorithms based on real-time feedback from ongoing incidents. This embodiment enables the system to refine its predictions of transaction impact counts by continuously learning from discrepancies between predicted and actual transaction volumes, thereby enhancing the accuracy of future incident impact assessments.

In another embodiment, the system 400 includes an adaptive feedback loop that utilizes input from user interactions on the dashboard to improve its incident impact analysis algorithms. This feedback loop allows operators to input observations regarding incident attributes or anomalies, which the system 400 then uses to update its knowledge base and refine its predictive capabilities for subsequent incidents.

In yet another embodiment, the AI engine is configured to interface with external data sources such as weather APIs or market trend databases to incorporate external variables that might correlate with transaction incidents or associated anomalies. By considering these external factors, the AI engine enhances its ability to predict incident impacts by accounting for additional external influences that may affect system performance during an incident.

In an alternative embodiment, the system incorporates a distributed ledger technology for secure and immutable recording of transaction data during an incident. This would allow for increased transparency and traceability of the transaction impacts, providing a reliable audit trail that can be used for further analysis or regulatory compliance.

Another embodiment involves utilizing edge computing resources to distribute the processing of transaction impact analysis closer to the data source. By processing data at the edge, the system can reduce latency and enhance the speed of impact assessments during an incident, particularly in environments with limited bandwidth or high data volume.

Furthermore, a potential embodiment involves integrating a natural language processing (NLP) module that processes unstructured data from incident reports, technical logs, or user comments to provide additional context for the incident impact analysis. This data fusion approach enhances understanding of the incident by identifying potential causal factors or interdependencies that are not immediately apparent from transaction data alone.

FIG. 5 is a block diagram illustrating an example incident impact dashboard 518. In some examples, the incident impact dashboard 518 is executed or otherwise implemented as part of or in association with systems such as system 100 of FIG. 1 and/or system 400 of FIG. 4. Additionally, or alternatively, in some examples, the display, configuration, and/or updating of the incident impact dashboard 518 are performed as part of methods such as method 200 of FIG. 2 and/or method 300 of FIG. 3.

In some examples, the incident impact dashboard 518 displays information about a specific incident which is identified using an incident number or identifier (ID) 530. An incident start datetime 532 and an incident end datetime 534 are also displayed in association with the incident number/ID 530. The resulting statistics of the incident, including the successful transactions 536, the success percentage 538, the failed transactions 540, and the failure percentage 542 are also displayed.

Further, in some examples, the incident impact dashboard 518 displays the impact of the incident in association with specific entities in an impact breakdown section 544. The impact breakdown section 544, as illustrated, includes an impact by region section 546 and a top country impact section 548, but in other examples, more, fewer, or different sections are included in the impact breakdown section 544 without departing from the description. The impact by region section 546 includes North America statistics 550, Africa statistics 552, Europe statistics 554, Asia statistics 556, and/or statistics 558 associated with another region. Each statistics section 550-558 displays statistics associated with the impact of the incident in the associated region (e.g., statistics including successful transactions, success percentage, failed transactions, and/or failure percentage). It should be understood that, in other examples, more, fewer, or different regional statistics sections are displayed in the impact by region section 546 without departing from the description.

Additionally, or alternatively, the top country impact section 548 includes country 1 statistics 560, country 2 statistics 562, country 3 statistics 564, country 4 statistics 566, and country 5 statistics 568. Each statistics section 560-568 displays statistics associated with the impact of the incident in the associated country (e.g., statistics including successful transactions, success percentage, failed transactions, and/or failure percentage). It should be understood that, in other examples, more, fewer, or different regional statistics sections are displayed in the top country impact section 546 without departing from the description.

In some examples, the incident impact dashboard 518 displays impact information about an incident while the incident is ongoing, rather than just the statistics associated with the incident after it is over.

Further, in some examples, the incident impact dashboard 518 is configured to enable the execution or performance of operations in response to or based on the determined incident impact. For instance, in an example, a notification is generated and/or presented on the incident impact dashboard 518 that indicates a recommended action that the notified user can take to end or otherwise address the incident. Alternatively, or additionally, in an example, the incident impact dashboard 518 includes displayed information associated with analyzing the incident, determining a method of detecting similar future incidents, and/or generating a system rule associated with preventing or otherwise reducing the effect of similar future incidents.

### Exemplary Operating Environment

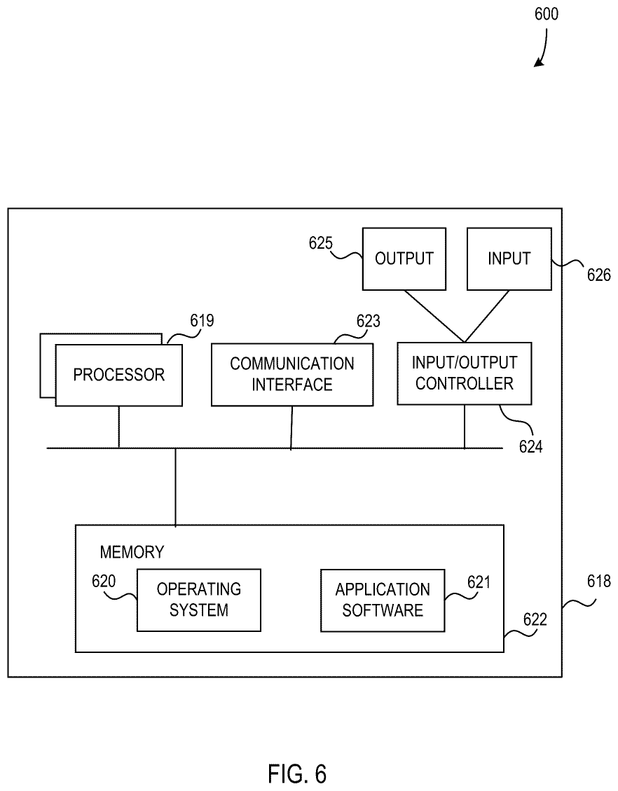

The present disclosure is operable with a computing apparatus according to an embodiment as a functional block diagram 600 in FIG. 6. In an example, components of a computing apparatus 618 are implemented as a part of an electronic device according to one or more embodiments described in this specification. The computing apparatus 618 comprises one or more processors 619 which may be microprocessors, controllers, or any other suitable type of processors for processing computer executable instructions to control the operation of the electronic device. Alternatively, or in addition, the processor 619 is any technology capable of executing logic or instructions, such as a hard-coded machine. In some examples, platform software comprising an operating system 620 or any other suitable platform software is provided on the apparatus 618 to enable application software 621 to be executed on the device. In some examples, determining impact of an incident during incubation period using the AI engine as described herein is accomplished by software, hardware, and/or firmware.

In some examples, computer executable instructions are provided using any computer-readable media that is accessible by the computing apparatus 618. Computer-readable media include, for example, computer storage media such as a memory 622 and communications media. Computer storage media, such as a memory 622, include volatile and non-volatile, removable, and non-removable media implemented in any method or technology for storage of information such as computer readable instructions, data structures, program modules or the like. Computer storage media include, but are not limited to, Random Access Memory (RAM), Read-Only Memory (ROM), Erasable Programmable Read-Only Memory (EPROM), Electrically Erasable Programmable Read-Only Memory (EEPROM), persistent memory, phase change memory, flash memory or other memory technology, Compact Disk Read-Only Memory (CD-ROM), digital versatile disks (DVD) or other optical storage, magnetic cassettes, magnetic tape, magnetic disk storage, shingled disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media does not include communication media. Therefore, a computer storage medium does not include a propagating signal. Propagated signals are not examples of computer storage media. Although the computer storage medium (the memory 622) is shown within the computing apparatus 618, it will be appreciated by a person skilled in the art, that, in some examples, the storage is distributed or located remotely and accessed via a network or other communication link (e.g., using a communication interface 623).

Further, in some examples, the computing apparatus 618 comprises an input/output controller 624 configured to output information to one or more output devices 625, for example a display or a speaker, which are separate from or integral to the electronic device. Additionally, or alternatively, the input/output controller 624 is configured to receive and process an input from one or more input devices 626, for example, a keyboard, a microphone, or a touchpad. In one example, the output device 625 also acts as the input device. An example of such a device is a touch sensitive display. The input/output controller 624 may also output data to devices other than the output device, e.g., a locally connected printing device. In some examples, a user provides input to the input device(s) 626 and/or receives output from the output device(s) 625.

The functionality described herein can be performed, at least in part, by one or more hardware logic components. According to an embodiment, the computing apparatus 618 is configured by the program code when executed by the processor 619 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

At least a portion of the functionality of the various elements in the figures may be performed by other elements in the figures, or an entity (e.g., processor, web service, server, application program, computing device, or the like) not shown in the figures.

Although described in connection with an exemplary computing system environment, examples of the disclosure are capable of implementation with numerous other general purpose or special purpose computing system environments, configurations, or devices.

Examples of well-known computing systems, environments, and/or configurations that are suitable for use with aspects of the disclosure include, but are not limited to, mobile or portable computing devices (e.g., smartphones), personal computers, server computers, hand-held (e.g., tablet) or laptop devices, multiprocessor systems, gaming consoles or controllers, microprocessor-based systems, set top boxes, programmable consumer electronics, mobile telephones, mobile computing and/or communication devices in wearable or accessory form factors (e.g., watches, glasses, headsets, or earphones), network PCs, minicomputers, mainframe computers, distributed computing environments that include any of the above systems or devices, and the like. In general, the disclosure is operable with any device with processing capability such that it can execute instructions such as those described herein. Such systems or devices accept input from the user in any way, including from input devices such as a keyboard or pointing device, via gesture input, proximity input (such as by hovering), and/or via voice input.

Examples of the disclosure may be described in the general context of computer-executable instructions, such as program modules, executed by one or more computers or other devices in software, firmware, hardware, or a combination thereof. The computer-executable instructions may be organized into one or more computer-executable components or modules. Generally, program modules include, but are not limited to, routines, programs, objects, components, and data structures that perform particular tasks or implement particular abstract data types. Aspects of the disclosure may be implemented with any number and organization of such components or modules. For example, aspects of the disclosure are not limited to the specific computer-executable instructions, or the specific components or modules illustrated in the figures and described herein. Other examples of the disclosure include different computer-executable instructions or components having more or less functionality than illustrated and described herein.

In examples involving a general-purpose computer, aspects of the disclosure transform the general-purpose computer into a special-purpose computing device when configured to execute the instructions described herein.

An example system comprises a processor; and a memory comprising computer program code, the memory and the computer program code configured to cause the processor to: detect a start of an incident; receive a stream of impacted transactions during the incident; identify a transaction traffic pattern, over a defined impacted time period, from the stream of impacted transactions; compare the identified transaction traffic pattern with data stored in a historical data warehouse, the data stored in the historical data warehouse comprising historical transaction traffic patterns prior to the incident; based on the comparing, determine a running impact count of transactions, the running impact count at least indicating a quantity of transactions predicted to be missed; display, in a dashboard user interface, the running impact count; dynamically update the running impact count as the incident is on-going; and dynamically adjust resource allocation of the system using the running impact count, wherein the adjusted resource allocation reduces system disruption of the incident.

An example computerized method for determining impact of an incident while the incident is occurring comprises: detecting a start of the incident; receiving a stream of impacted transactions during the incident; identifying at least one transaction traffic pattern, over a defined impacted time period, from the stream of impacted transactions; comparing the identified transaction traffic pattern with data stored in a historical data warehouse, the data stored in the historical data warehouse comprising historical transaction traffic patterns prior to the incident; based on the comparing, determining a running impact count of transactions, the running impact count at least indicating a quantity of transactions predicted to be missed; displaying, in a dashboard user interface, the running impact count; and dynamically updating the running impact count as the incident is on-going.

A computer storage medium has computer-executable instructions that, upon execution by a processor, cause the processor to at least: detect a start of an incident; receive a stream of impacted transactions during the incident; identify at least one transaction traffic pattern, over a defined impacted time period, from the stream of impacted transactions; compare the identified transaction traffic pattern with data stored in a historical data warehouse, the data stored in the historical data warehouse comprising historical transaction traffic patterns prior to the incident; based on the comparing, determine a running impact count of transactions, the running impact count at least indicating a quantity of transactions predicted to be missed; display, in a dashboard user interface, the running impact count; and dynamically update the running impact count as the incident is on-going.

Alternatively, or in addition to the other examples described herein, examples include any combination of the following:
further comprising: identifying a statistically similar time period to the defined impacted time period; extracting, from the data stored in the historical data warehouse, the historical transaction traffic patterns associated with the statistically similar time period; and applying deduplication to the historical traffic patterns associated with the statistically similar time period to get an accurate view of an impact of the incident.
further comprising: creating, in real-time, a comparable data set as the stream of transactions is received.
wherein the comparable data set is created in real-time upon detecting the start of the incident, wherein the comparable data set is to be used as an incident affected baseline.
wherein the running impact count displayed in the dashboard user interface comprises one or more of a number of transactions impacted, an expected volume of transactions, an actual volume of transactions, a percentage of volume impact, or a percentage of volume successful.
further comprising: detecting an end of the incident; upon detecting the end of the incident, determining a final impact count based on the data stored in the historical data warehouse; and displaying, in the dashboard user interface, the final impact count.
wherein the final impact count provides a breakdown of data by one or more of: a country, a region, a customer, or a message type.

Any range or device value given herein may be extended or altered without losing the effect sought, as will be apparent to the skilled person.

Examples have been described with reference to data monitored and/or collected from the users (e.g., user identity data with respect to profiles). In some examples, notice is provided to the users of the collection of the data (e.g., via a dialog box or preference setting) and users are given the opportunity to give or deny consent for the monitoring and/or collection. The consent takes the form of opt-in consent or opt-out consent.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It will be understood that the benefits and advantages described above may relate to one embodiment or may relate to several embodiments. The embodiments are not limited to those that solve any or all of the stated problems or those that have any or all of the stated benefits and advantages. It will further be understood that reference to ‘an’ item refers to one or more of those items.

The embodiments illustrated and described herein as well as embodiments not specifically described herein but within the scope of aspects of the claims constitute an exemplary means for detecting a start of the incident; exemplary means for receiving a stream of impacted transactions during the incident; exemplary means for identifying at least one transaction traffic pattern, over a defined impacted time period, from the stream of impacted transactions; exemplary means for comparing the identified transaction traffic pattern with data stored in a historical data warehouse, the data stored in the historical data warehouse comprising historical transaction traffic patterns prior to the incident; based on the comparing, exemplary means for determining a running impact count of transactions, the running impact count at least indicating a quantity of transactions predicted to be missed; exemplary means for displaying, in a dashboard user interface, the running impact count; and exemplary means for dynamically updating the running impact count as the incident is on-going.

The term “comprising” is used in this specification to mean including the feature(s) or act(s) followed thereafter, without excluding the presence of one or more additional features or acts.

In some examples, the operations illustrated in the figures are implemented as software instructions encoded on a computer readable medium, in hardware programmed or designed to perform the operations, or both. For example, aspects of the disclosure are implemented as a system on a chip or other circuitry including a plurality of interconnected, electrically conductive elements.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

When introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

What is claimed is:

1. A system comprising:
a processor; and
a memory comprising computer program code, the memory and the computer program code configured to cause the processor to:
detect a start of an incident;
receive a stream of impacted transactions during the incident;
identify a transaction traffic pattern, over a defined impacted time period, from the stream of impacted transactions;
compare the identified transaction traffic pattern with data stored in a historical data warehouse, the data stored in the historical data warehouse comprising historical transaction traffic patterns prior to the incident;
based on the comparing, determine a running impact count of transactions, the running impact count at least indicating a quantity of transactions predicted to be missed;
display, in a dashboard user interface, the running impact count;
dynamically update the running impact count as the incident is on-going; and
dynamically adjust resource allocation of the system using the running impact count, wherein the adjusted resource allocation reduces system disruption of the incident.

2. The system of claim 1, wherein the memory and the computer program code are configured to further cause the processor to:
identify a statistically similar time period to the defined impacted time period;
extract, from the data stored in the historical data warehouse, the historical transaction traffic patterns associated with the statistically similar time period; and
apply deduplication to the historical traffic patterns associated with the statistically similar time period to get an accurate view of an impact of the incident.

3. The system of claim 1, wherein the memory and the computer program code are configured to further cause the processor to:
create, in real-time, a comparable data set as the stream of transactions is received.

4. The system of claim 3, wherein the comparable data set is created in real-time upon detecting the start of the incident, wherein the comparable data set is to be used as an incident affected baseline.

5. The system of claim 1, wherein the running impact count displayed in the dashboard user interface comprises one or more of a number of transactions impacted, an expected volume of transactions, an actual volume of transactions, a percentage of volume impact, or a percentage of volume successful.

6. The system of claim 1, wherein the memory and the computer program code are configured to further cause the processor to:
detect an end of the incident;
upon detecting the end of the incident, determine a final impact count based on the data stored in the historical data warehouse; and
display, in the dashboard user interface, the final impact count.

7. The system of claim 6, wherein the final impact count provides a breakdown of data by one or more of: a country, a region, a customer, or a message type.

8. A computerized method for determining impact of an incident while the incident is occurring, the method comprising:
detecting a start of the incident;
receiving a stream of impacted transactions during the incident;
identifying at least one transaction traffic pattern, over a defined impacted time period, from the stream of impacted transactions;
comparing the identified transaction traffic pattern with data stored in a historical data warehouse, the data stored in the historical data warehouse comprising historical transaction traffic patterns prior to the incident;
based on the comparing, determining a running impact count of transactions, the running impact count at least indicating a quantity of transactions predicted to be missed;
displaying, in a dashboard user interface, the running impact count; and
dynamically updating the running impact count as the incident is on-going.

9. The computerized method of claim 8, further comprising:
identifying a statistically similar time period to the defined impacted time period;
extracting, from the data stored in the historical data warehouse, the historical transaction traffic patterns associated with the statistically similar time period; and
applying deduplication to the historical traffic patterns associated with the statistically similar time period to get an accurate view of an impact of the incident.

10. The computerized method of claim 8, further comprising:
creating, in real-time, a comparable data set as the stream of transactions is received.

11. The computerized method of claim 10, wherein the comparable data set is created in real-time upon detecting the start of the incident, wherein the comparable data set is to be used as an incident affected baseline.

12. The computerized method of claim 8, wherein the running impact count displayed in the dashboard user interface comprises one or more of a number of transactions impacted, an expected volume of transactions, an actual volume of transactions, a percentage of volume impact, or a percentage of volume successful.

13. The computerized method of claim 8, further comprising:
detecting an end of the incident;
upon detecting the end of the incident, determining a final impact count based on the data stored in the historical data warehouse; and
displaying, in the dashboard user interface, the final impact count.

14. The computerized method of claim 13, wherein the final impact count provides a breakdown of data by one or more of: a country, a region, a customer, or a message type.

15. A computer storage medium has computer-executable instructions that, upon execution by a processor, cause the processor to at least:
detect a start of an incident;
receive a stream of impacted transactions during the incident;
identify at least one transaction traffic pattern, over a defined impacted time period, from the stream of impacted transactions;
compare the identified transaction traffic pattern with data stored in a historical data warehouse, the data stored in the historical data warehouse comprising historical transaction traffic patterns prior to the incident;
based on the comparing, determine a running impact count of transactions, the running impact count at least indicating a quantity of transactions predicted to be missed;
display, in a dashboard user interface, the running impact count; and
dynamically update the running impact count as the incident is on-going.

16. The computer storage medium of claim 15, wherein the computer-executable instructions, upon execution by a processor, further cause the processor to at least:
identify a statistically similar time period to the defined impacted time period;
extract, from the data stored in the historical data warehouse, the historical transaction traffic patterns associated with the statistically similar time period; and
apply deduplication to the historical traffic patterns associated with the statistically similar time period to get an accurate view of an impact of the incident.

17. The computer storage medium of claim 15, wherein the computer-executable instructions, upon execution by a processor, further cause the processor to at least:
create, in real-time, a comparable data set as the stream of transactions is received.

18. The computer storage medium of claim 17, wherein the comparable data set is created in real-time upon detecting the start of the incident, wherein the comparable data set is to be used as an incident affected baseline.

19. The computer storage medium of claim 15, wherein the running impact count displayed in the dashboard user interface comprises one or more of a number of transactions impacted, an expected volume of transactions, an actual volume of transactions, a percentage of volume impact, or a percentage of volume successful.

20. The computer storage medium of claim 15, wherein the computer-executable instructions, upon execution by a processor, further cause the processor to at least:
detect an end of the incident;
upon detecting the end of the incident, determine a final impact count based on the data stored in the historical data warehouse; and
display, in the dashboard user interface, the final impact count.
